(19) United States
(12) Patent Application Publication
(10) Pub. No.: US 2007/0153763 A1
(43) Pub. Date: Jul. 5, 2007

(54) Route change monitor for communication networks

(76) Inventors: Richard A. Rampolla, Hillsborough, NJ (US); David Thomas Stott, Basking Ridge, NJ (US)

Correspondence Address: HARNESS, DICKEY & PIERCE, P.L.C., P.O. BOX 8910, RESTON, VA, 20195, US

(21) Appl. No.: 11/320,417

(22) Filed: Dec. 29, 2005

(51) Int. Cl. H04L 12/28; H04L 12/26

(52) U.S. Cl. 370/351; 370/230

(57) ABSTRACT

Methods, systems, and network entities for detecting route changes, validating the route changes, and/or remediating potential attacks by blocking traffic over potentially compromised paths.

### STATEMENT REGARDING FEDERALLY SPONSORED RESEARCH OR DEVELOPMENT

This invention was made with Government support. The Government has certain rights in this invention.

### BACKGROUND OF THE INVENTION

Conventional communication networks allow distant users to transmit data. Open networks, for example, the public Internet, may be used to connect remote sites to corporate offices, which often carry sensitive data. The corporations typically have no control over the path or route that the data will traverse. As a result, some corporations may be concerned that their sensitive data may be vulnerable to being routed through non-ideal and/or lower-performing networks. Such re-routing may be the result of normal Internet activities, for example, a response to congestion and/or link failures, or may be the result of malicious activities, for example, an attacker subverting traffic or an unscrupulous backbone provider rerouting its competitor's traffic over lower-performing ISPs circuits.

When sending sensitive data over the public Internet, users may want to protect the confidentiality of their data. In particular, adversaries, for example, competitors, may attempt to reroute the traffic so that the public Internet routes the traffic through their equipment, whereby they can read the IP headers, attempt to decrypt the traffic offline, and/or attempt man-in-the-middle attacks. Currently, very little can be done prevent, or even detect, these types of attack.

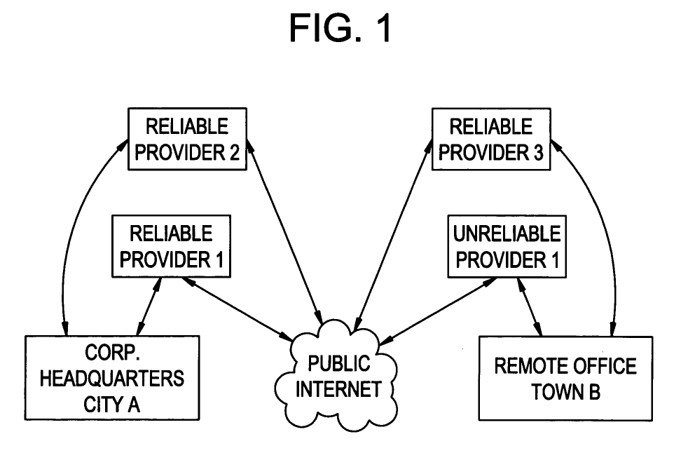

For example, one may be concerned that an adversary could intercept sensitive data by rerouting a connection to a remote office. Should an adversary succeed in rerouting the traffic, the communication link should be terminated until the routing issue is resolved. FIG. 1 illustrates an example conventional network in which such a scenario could occur.

In the example network, a corporation has its headquarters in City A and a remote branch office in Town B. The corporation may be currently working on a deal that may adversely affect one of their competitors. The corporation may be concerned that one of their competitors could learn about the deal by capturing the traffic between the two sites in City A and Town B.

The corporation may be comfortable with certain providers handling their traffic, for example, Reliable Providers 1-3, but may have little choice about some providers, for example, Unreliable Provider 1, because connectivity choices may be limited in and near Town B. The corporation may be concerned that the traffic may go to certain providers in Town B, for example, Unreliable Provider 1, that have peering arrangements with, potentially including competitors of the corporation.

As shown in the example conventional network of FIG. 1, the public Internet may be component of a corporate headquarters and one or more remote branch offices. Message routing within the public internet may include layer 3 routing, layer 2 routing, and other routing mechanisms, as generally described below.

The public Internet is divided into tens of thousands of independently managed autonomous systems (AS). Each AS may be assigned an autonomous system number (ASN). An AS may represent a service provider, a company, a university, a peering point (e.g., a network access point (NAP)), etc.

Internet Registries (e.g., ARIN and RIPE) may maintain registration information about each AS. For example, ARIN has a database that includes, among other things, the owner and administrative contacts for each AS. The registries may include a mapping between IP addresses and ASNs so that one can find the owner of any particular IP address. The IP address ranges advertised over Border Gateway Protocol (BGP-4) may be referred to as IP address prefixes, or simply prefixes.

BGP may be the basis for routing in the Internet between ASes. Each BGP router may maintain a table with its view about global routing. In particular, each BGP router may record the shortest path to each destination prefix (where shortest equates to the number of ASes in the path). Each path may include a list of the ASes along the path to the prefix. The protocol may send updates directly between BGP routers when there is a change in the network topology that affects any of the router's routes. Routers may also obtain an entire copy of a neighboring router's BGP table.

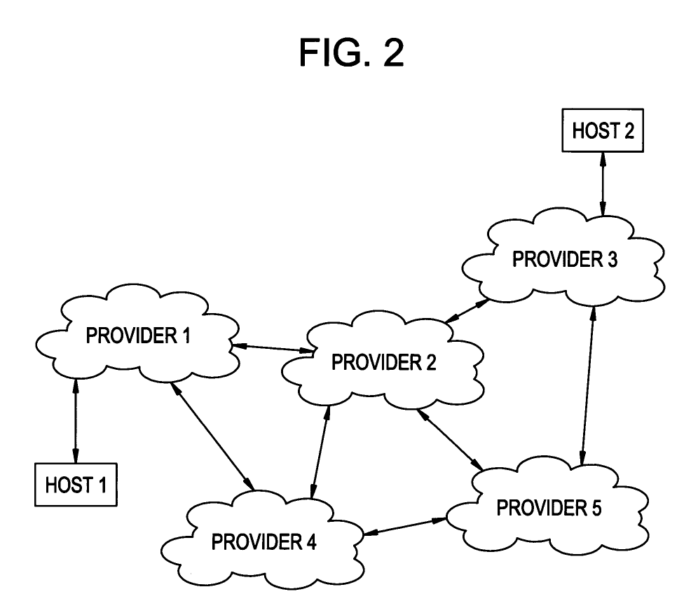

FIG. 2 shows an example subset of the conventional network to demonstrate how BGP determines paths. In FIG. 2, each provider 1-5 is an AS. The arrows show the paths to a host connected to Provider 3. As illustrated, providers 1 and 2 also have paths to provider 3 through provider 4 and provider 5, but the resulting path would have a longer path (e.g., go through more ASes).

Each AS may control how packets are routed inside the AS. For example, each provider could use an open shortest path first (OSPF), routing interchange protocol (RIP), or static routing techniques internally. Other providers may move their entire core network to Multiple Protocol Label Switching (MPLS), discussed in more detail below in conjunction with layer 2 routing. Hiding these details from the inter-AS routing (e.g., BGP) may make routing globally scalable.

Layer 2 routing technologies, for example, asynchronous transfer mode (ATM) and MPLS, may also be used to connect remote hosts. For example, ATM may be used to establish telephony services to remote locations. Fundamentally, layer 3 may provide global end-to-end connectivity between hosts, whereas layer 2 may operate at a lower level to provide connectivity between layer-3 hops (e.g., between a pair of routers). MPLS is somewhat of an exception because MPLS may be layered over another layer-2 technology and may use IP in its control plane.

A difference between layer 2 technologies (for example, ATM, MPLS, and Frame Relay) and layer 3 technologies (e.g., IP) may be that packets are routed over virtual circuits instead of best effort approaches (e.g., BGP routes). With virtual circuits, the end-to-end path may be determined before packets (cells or frames, depending on the technology) are transmitted. The path may be essentially static, but can be rerouted to account for failures (e.g., a link failure).

When establishing these types of connections, a user may negotiate with the provider to establish the connection at some service level (e.g., a guaranteed bandwidth or delay or number of concurrent calls) with the specific interface (e.g., ATM or frame relay) at each end. The provider may provision a path through the global network to accommodate the necessary service level. It is common for providers to resell service to each other. For example, in many locations it may be more economically feasible for a provider to buy service from a competitor than to install their own switching equipment and/or transmission lines. In some cases, the traffic uses lines or equipment may be operated as a public utility (or government operated equipment in some countries).

ATM may be used for data connections across distant points. Because ATM operates at layer 2, it is not subject to layer 3 routing attacks, for example, BGP-based attacks. ATM, like most networks, has reliability features to reroute traffic around normally faults (for example, link failures). Route changes of this nature do not constitute an attack. In general, the ATM network hides information about routing changes from the end user.

There are no in-band ATM mechanisms to detect route changes inside an ATM network. Such changes may result in momentary delays or drops in throughput that would be detectable. Because these characteristics occur in a normally behaving network (e.g., due to congestion), they do not form a robust mechanism for detecting topology changes.

ATM providers may use network management systems (NMS) to monitor their internal network. NMS systems may provide features for detecting network faults, setting up network routes (e.g., PVC), provisioning (e.g., monitoring and/or optimizing link usages), etc. NMS systems may collect data using a combination of simple network management protocol (SNMP), vendor-proprietary mechanisms, and manual configuration. Some, more advanced NMS systems may correlate alarms (even from resellers' networks) from devices and additional data, for example, to provide root cause analysis of network faults in real time.

Some providers offer service packages that include permission to read results from their NMS system. For example, the provider may allow the customer to read data from the NMS to verify service level agreements (SLA), respond quickly to network outages, view network paths, examine their PVC, etc. Reselling service poses a challenge for this type of service offering because the original provider generally lacks permission to obtain the management data from the reseller's network. In a typical case, the reseller may generate alarms for the original provider, but not allow the NMS direct access into their networks.

Some MPLS networks provide mechanisms to divulge MPLS data (e.g., the label and an IP address for each MPLS hop). The Internet Engineering Task Force (IETF) had a draft for a mechanism for tracing a route through an MPLS network that is similar to traceroute (e.g., both rely on IP TTL behavior to select a network device along the path). The MPLS echo reply (based on an Internet Control Message Protocol (ICMP) echo) includes MPLS information for example, the MPLS label. Most MPLS routers, but not all, currently provide this feature.

Individual providers, as with ATM, may have NMS tools for provisioning and monitoring MPLS networks. As set forth above, such tools may only be applicable to a single provider's network.

Conventional tools that attempt to address the problem discussed above may require direct access (e.g., SNMP) to the network devices along the path. These tools, with SNMP access, may be capable of building a complete topology of a network (for layer-3, layer-2 (e.g., ATM, frame relay), or MPLS) and trap any changes to the paths and includes element management components that use SNMP to collect raw data (e.g., interface tables, routing tables, address translation tables) from multiple technologies (e.g., ATM, frame relay, Wireless access, Ethernet). Other components may use this data to determine the network paths through these devices.

Various traceroute programs are also available supporting different features. Two particularly useful features are AS paths and MPLS labels. Open source tool (e.g., prtraceroute and LFT) may use the Internet registries (e.g., the whois service) to lookup the ASN for each IP address on the path. Other open source tools may not only provide the ASN, but may also show MPLS labels along the path.

There are several categories of approaches for detecting route changes. These may be divided into detection approaches, including traceroute-based, metrics-based, and routing-based approaches, verification approaches, rectification approaches, and route diversification.

Traceroute is a program that sends queries over the public Internet between two hosts (or routers) to discover the actual path packets take from the source to the destination. Only IP hops (e.g., routers) may be considered, not layer 2 devices (for example, switches). The result may be a list of addresses used by each router and their distance from the source (e.g., if the router does not reply, the program detects that it missed a hop).

A system could periodically run traceroute between the sites and detect when the route changes. The probes would need to run outside of the encrypted VPN tunnel, as the tunnel itself is a single IP hop (encapsulated over the real IP path). For example, the gateway router could run the probe. Because the Internet provides asymmetric routes (e.g., the path from A to B is often different than that of B to A), an effective solution would need to run traceroute in both directions (e.g., Corporate headquarters in City A to the remote office in Town B and the office in Town B to the headquarters in City A).

Several common Internet procedures make it difficult to separate typical route changes from malicious ones. For example, many routers are configured in redundant pairs. Consecutive probes may use either router in the pair. Individual providers generally have multiple paths through their core network to accommodate congestion and link or router failures. For example, providers may change the paths to account for diurnal traffic patterns shift across global networks throughout the day. They may also change paths to circumvent dynamic congestion caused, for example, to accommodate additional traffic spilling over from a neighboring provider experience an equipment failure. Similar dynamic patterns can be seen between providers due to congestion, new peering agreements between providers, and the addition of new links. It is not uncommon for the paths to changes for a few days as the Internet stabilizes in response to these sorts of changes.

The second category includes approaches that detect behavior changes in a path. One example is using a ping to monitor the round trip time between the routers. The idea behind such an approach is that modifying a route to divert the path will add delay to the path. Unfortunately, metrics, for example, round trip time, are extremely variable in the Internet and in layer 2 technologies over long distances. Thus, these techniques result in many false positives and often do not detect malicious changes.

A third category includes approaches that examine the Internet routing tables (e.g., Border Gateway Protocol (BGP) routing tables). A simple approach in this category is to monitor the BGP routes between the hosts (as observed by their nearest BGP router). A more involved approach coordinates BGP feeds from several routers along the path(s) between the hosts (e.g., one from each AS). The basis for these techniques is that any change to the Internet routing would be detectable in updates to the Internet routing tables (e.g., the BGP tables).

Providers may make BGP feeds available to their customers. For example, customers with their own AS may exchange BGP data with their providers. In particular, the customer can purchase connections from multiple providers including access to obtain BGP feeds. When any AS makes a change that affects routing to a destination, the change propagates to all routers whose path to the destination changes. There are no analogous approaches for layer 2.

Once a change to the topology is detected, the change may be classified as acceptable or not. An acceptable change may be rerouting between acceptable providers in response to congestion or a link failures. Unacceptable changes include malicious or inadvertent routing changes and any changes to untrusted networks.

A conventional approach may categorize Autonomous Systems (AS) into trusted, untrusted, and uncategorized providers. The trusted providers may be listed on a “whitelist”. The untrusted providers may be listed on a “blacklist”. Uncategorized providers (e.g., those on neither list) are treated like blacklisted providers until they can be examined and found to be trustworthy.

The mapping from IP address to ASN may be found in one of two locations. Internet Registries (e.g., ARIN and RIPE) provide mappings from IP addresses to AS numbers (ASN) that are available using the “whois” protocol or as an offline database. The BGP table lists the actual AS advertising each prefix. The Registries often contain errors (e.g., because someone incorrectly entered the data, or because the data recently changed). Some routing attacks may produce a false mapping. For example, when an attacker injects a false advertisement in an attempt to steal routes to a prefix, the attacker can specify a false AS for the prefix (e.g., the destination where he wants to send the traffic).

This mapping (between IP addresses and ASN) may be useful for determining which provider owns a particular address observed along a path. For example, some public traceroute applications use this type of mapping to output the ASN of each hop, which may provide a way to determine if a router (identified by its IP address) belongs to a whitelisted or blacklisted provider.

Depending on the detection method, the verification may need to run traceroute to get the list of IP addresses along the path, or it may already have the list IP address on the path and need to convert the IP address into ASNs. For each router along the path, a system may determine if the router is acceptable or not (based the whitelist and blacklist). If any address along the route is not on the whitelist, the system may flag a violation. If the address belongs to the blacklist, the path is bad (by definition of the blacklist). If the address is uncategorized, the system may treat the address as a violation immediately or require an operator to intervene and examine the route before taking action.

After detecting an attack, the next action may be to block each end from sending traffic over the compromised link. One could remotely disable the interface through the gateway device's administrative interface. This may be risky because the path to the administrative interface may be compromised (along with the normal traffic). A safer approach to rectification may be for the process to include placing a telephone call to the remote office to instruct the IT personnel to disable its connection (e.g., by powering off the gateway).

An alternative approach may be to provide many routes and split the traffic across the paths. The idea behind this approach is that an attacker would need to modify all of the paths to get a useful piece of data. This approach is somewhat theoretical, but is supported in existing routers by using features for load sharing and link aggregation.

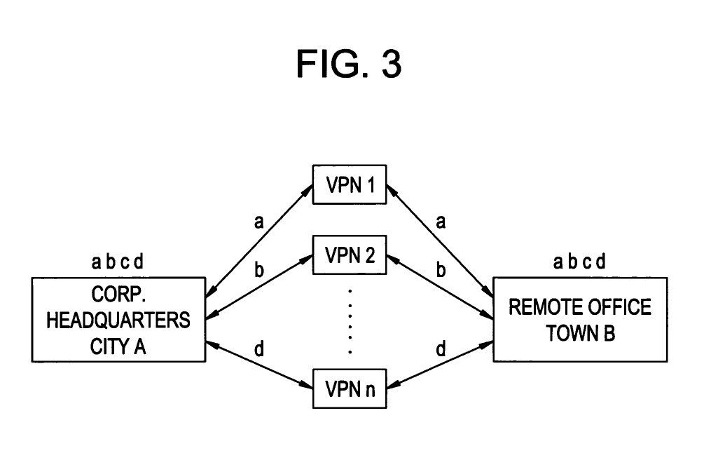

FIG. 3 illustrates an example of route diversification. Instead of having a single VPN connection between the remote office in Town B and the corporate headquarters in City A, there may be multiple VPNs between the remote office and several secured locations (e.g., other remote offices or ASPs) and VPNs between those locations and the headquarters. The sensitive data transmitted between the remote office and the corporate headquarters may be divided over the multiple links so that a compromise to a single link would not provide enough data for the attacker to learn the original data.

One difficulty with this approach is that the remote site often has a single physical link for it first hop that is common to all the paths. Another difficulty, especially when one or more of the paths uses a limited bandwidth or high delay link (e.g., a satellite link), is that performance will be reduced to (or below) that of the worst link.

As set forth above, routing protocols may be subject to various forms of attack (malicious or otherwise). An attacker may have one or more objectives for the attack. One objective, called black-holing, is where paths lead to a “black hole” where they cannot escape, and hence, do not reach their intended destination. Another objective is redirection, where the chosen path is a different (e.g., non-optimal) route to the destination. With subversion, a special case of redirection, the attacker reroutes packets through a location where the attacker can read (or modify) the traffic. For another objective, called instability, the attacker manipulates routing protocol to cause it to become unstable, resulting in a denial of service (DoS) attack.

Table 1 includes an example list of specific attacks an attacker may use to attain the objective.

TABLE 1

| Threat | Description |
|---|---|
| Path Padding | Attacker inserts multiple instances of the |
| | same AS in a path so that upstream peers |
| | select a different path. |
| False Route | Attacker advertises false short path |
| | including target AS. |
| Address | Attacker claims to own victim's prefix |
| Ownership | for which it has no authority and |
| Violation | advertises path to the prefix. This |
| | condition may be referred to as Multiple |
| | Origin AS (MOAS). |
| Advertent | An attacker causes BGP dampening features to |
| Flapping | effectively block a valid link (e.g., by |
| | sending withdrawal and reannouncing methods |
| | to emulate route flapping). |
| De-aggregation | Attacker falsifies advertisement for specific |
| | subset of existing route advertisement. |
| | Attacker can selectively reroute specific |
| | prefixes without affecting all addresses. |
| Contradictory | Attacker advertises different paths for the |
| Advertisements | same prefix. |
| Bogon Route | An AS advertises bogon (e.g., the private |
| Injection | 10.0.0.0/8 network, special-purpose (e.g., |
| | 127.0.0/8 loopback addresses), or unallocated) |
| | prefixes confusing improperly configured |
| | routers at some ASes to route these non-global |
| | addresses to the advertising AS. |
| Resource | An attacker depletes a victim BGP router's |
| Exhaustion | resources (e.g., by opening an excessive |
| | number or BGP sessions or advertising |
| | countless small prefixes) to cause the router |
| | to fail or flap often resulting in instability. |
| Operational | Certain operational anomalies, for example, |
| Considerations | the Code Red II or Nimda Worms had adverse |
| | affects on the stability of BGP routers. An |
| | attacker could attempt to emulate these |
| | conditions to affect the routers. |
| Equipment | An attacker may be able to exploit |
| Vulnerabilities | implementation errors in BGP routers. |
| BGP Attributes | An attacker exploit BGP attributes, for |
| | example, communities. |
| Cascade | The transitive nature of BGP prefixes suggests |
| Failures | that it may be possible for a single failure |
| | to cascade through the entire Internet. |

### SUMMARY OF THE INVENTION

Example embodiments of the present invention relate to monitoring communication networks to detect routing changes.

In example embodiment, the present invention is directed to methods, systems, and network entities for detecting route changes, validating the route changes, and/or remediates potential attacks by blocking traffic over potentially compromised paths.

Example embodiments of the present invention may use one or more sensors that have access to routing updates. The sensor(s), in response to a routing update, may detect a change and notify a data collection server or servers. The sensor(s) and/or the data collection server(s) may have access to a list of networks and/or network elements that are acceptable for use. The sensor(s) and/or the data collection server(s) may validate the route change to determine if the new path uses acceptable networks and/or elements. Unvalidated route changes may be reported to block the unauthorized path.

Routing changes that affect paths through communication networks (e.g., the Internet) may be propagated via routing protocols (e.g., Border Gateway Protocol (BGP)). Malicious users may attempt to reroute traffic (e.g., to subvert traffic). Methods, systems, and network entities in accordance with example embodiments of the present invention may use or include one or more sensors that have access to routing updates. Methods, systems, and network entities in accordance with example embodiments of the present invention may use one or more sensors that subscribe to routing updates (e.g., BGP updates propagate through all BGP routers). The sensors, in response to a routing update (e.g., in response to link failures, congestion, or malicious activities), may detect the change (and optionally filters innocuous changes) and notify a data collection server (or servers). The sensor(s) and/or the data collection server(s) may optionally validate the route change to determine if the new path uses acceptable networks and/or elements. Validation may be performed, for example, using a traceroute utility and/or a whois service. Validated route changes (or unchecked ones) may be reported to other (for example, preconfigured) locations to block the path (e.g., by notifying the network access devices at each site and/or by notifying an administrator at each site who can manually to disable the network access device).

Methods, systems, and network entities in accordance with example embodiments of the present invention may:
1. detect when the network topology changes,
2. verify that the change is an attack (as opposed to normal routing changes to accommodate congestion or link failures), and/or
3. rectify the problem by blocking the traffic at the source until the original path is restored.

Detection may involve detecting potentially malicious routing changes. Various techniques, described in more detail, below may be applied for detection. Verification may include determining if the route change is acceptable. For example, it is normal for Internet paths to move between providers in response to congestion or between routers belonging to the same provider. Once an unacceptable path change has been detected, both ends may be prevented from sending traffic over the potentially compromised path.

Example embodiments of the present invention relate to monitoring communication networks to detect routing changes in various layers, for example, layer 2, using a spanning tree algorithm, or layer 3, using BGP updates.

Example embodiments of the present invention will become more fully understood from the detailed description given below and the accompanying drawings, which are given for purposes of illustration only, and thus do not limit the invention.

FIG. 1 illustrates an example conventional network.

FIG. 2 shows an example subset of the conventional network demonstrating how BGP determines paths.

FIG. 3 illustrates an example of conventional route diversification.

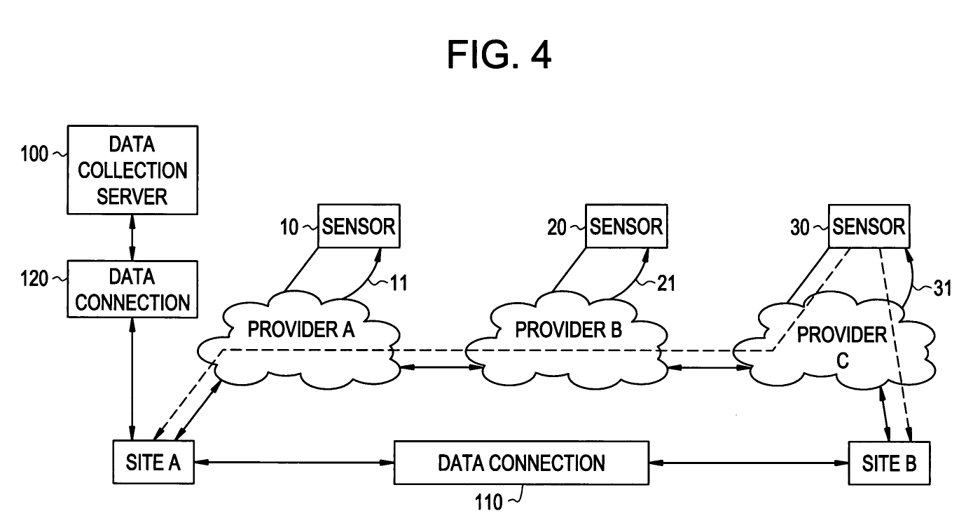

FIG. 4 illustrates a system in accordance with an example embodiment of the present invention.

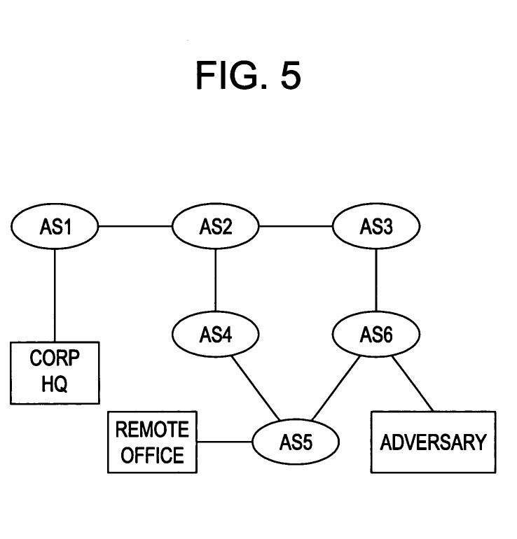

FIG. 5 illustrates an example of subversion mitigation performed by an example embodiment of the present invention.

It should be noted that these Figures are intended to illustrate the general characteristics of methods and devices of example embodiments of this invention, for the purpose of the description of such example embodiments herein. These drawings are not, however, to scale and may not precisely reflect the characteristics of any given embodiment, and should not be interpreted as defining or limiting the range of values or properties of example embodiments within the scope of this invention.

### DETAILED DESCRIPTION OF EXAMPLE EMBODIMENTS

In example embodiments, the present invention is directed to methods, systems, and network entities for detecting route changes, validating the route changes, and/or remediating potential attacks by blocking traffic over potentially compromised paths.

In example embodiments, the present invention is directed to methods, systems, and network entities for detecting malicious rerouting in the public Internet at layer 3.

In example embodiments, the present invention may include and/or utilize one or more sensors, along a path between two or more sites. For example, one or more sensors could be placed at one or more AS along the known path and/or one or more sensors could be placed at each site's provider. In general, the more sensors included and/or utilized, the more likely a malicious attack will be detected. In example embodiments, the sensors may connect remotely to the provider(s). For example, BGP may include a “virtual connection” feature to send BGP messages over a virtual link.

In example embodiments, the one or more sensors may subscribe to route change notifications and filter the notifications, based on rules. For example, a sensor may be configured to only report changes to a given set of prefixes and/or only outputs route changes of interest.

In example embodiments, the present invention may include and/or utilize one or more data collection servers (DCS). In example embodiments, a DCS may be a remote server, a specialized sensor with the addition functionality of a DCS, a server at one of the sites, etc. In example embodiments, the one or more sensors may report their results to one or more DCSs. In an example embodiment, each sensor may assume the role of a DCS. In an example embodiment, it may be convenient to have a smaller number of stand-alone DCSs to manage the results from a larger number of sensors. Similar to the sensor, each DCS may also be capable of filtering the results to examine only a subset of the route changes. For example, a DCS may be configured to only consider a small list of target prefixes.

In response to a route change, any component (e.g., the DCS, a sensor, a remote host, a host or router at either site) may run a utility, for example, traceroute (e.g., Internet Engineering Task Force (IETF) Request for Comment (RFC) 1393), to verify the routing protocol-determined path with the actual network path. Various techniques, for example, the “whois” service or a database with stored mappings, can be used to map the address in the network path to the provider operating the given network device.

Additionally, in example embodiments, one or more of the aforementioned path tracing techniques may be used to verify that an update has not been received from a given sensor. For example, the path tracing techniques could detect a routing change even if one of the sensors was lost or disconnected from the network.

After verifying that the path has changed, example embodiments of the present invention may generate an alarm to notify another system component and/or an operator that the path has been changed. Example embodiments of the present invention may be configured to automatically disable the path. For example, the alarm could trigger the access routers at each site to stop communicating with each other. In other example embodiments, the alarm could be reported to an operator. For example, the alarm could be a Simple Network Management Protocol (SNMP) trap that integrates with the user's network management system (NMS). For example, when the operator sees the alarm, he could place a telephone call to the sites to have their operators block the connection. Example embodiments could employ any combination of these and other remedial actions.

FIG. 4 illustrates a system in accordance with an example embodiment of the present invention. As shown, FIG. 4 includes two sites, site A and site B. In an example embodiment, site A may be a corporate headquarters and site B may be a remote office. In an example embodiment, site B may have a prefix of 192.0.2.0/24 for its addresses. As shown, a path between site A and site B may travel through several ISPs, for example, provider A, provider B, and provider C. FIG. 4 further illustrates one or more sensors 10, 20, 30. In the example embodiment of FIG. 4, a sensor 10, 20, 30 is provided for each provider A, B, C, however, the placement of the sensors 10, 20, 30 may vary. For example, a sensor could be collocated with one or more of the sites A, B. Further, it is not essential for every provider A, B, C to have a sensor 10, 20, 30 (or only one sensor 10, 20, 30).

FIG. 4 further illustrates a data collection server 100, connected to provider A. Similar to the sensors 10, 20, 30 discussed above, in example embodiments, one or more data collection servers 100 may be located at any location in FIG. 4.

FIG. 4 further illustrates a data connection 110 between the sites A, B. In an example embodiment of the present invention, the data connection 110 may be a virtual private network (VPN). A VPN may provide a secure, logical connection between two sites. In an example embodiment of the present invention, encrypted VPN traffic may follow the basic Internet path through various providers; in the example of FIG. 4, providers A, B, and C. In other instances, the sites A, B may connect over the public Internet without using a VPN.

FIG. 4 further illustrates a data connection 120 between the data collection server 100 and site A. In an example embodiment of the present invention, the data connection 120 may also be a VPN. In other example embodiments of the present invention, the data collection server 100 may connect directly to one or more of the sites A, B using the public Internet path and without a VPN.

In example embodiments, the present invention is directed to methods, systems, and network entities that make use of the BGP. In example embodiments, the methods, systems, and network entities have BGP connections to each of the endpoint's providers and/or to each of the providers along the path between the two sites (e.g, sites A, B).

As shown in FIG. 4, one or more of the sensors 10, 20, 30 may receive BGP updates from one or more of providers A, B, C. In example embodiments, the BGP updates 11, 21, 31 may be obtained, for example, by purchasing service from the provider, or negotiating the right from the provider to connect to their BGP router (e.g., connect remotely the BGP port on their router(s) along with necessary credentials (in particular, the provider agrees not to block the system from obtaining BGP updates).

In example embodiments, methods, systems, and network entities may report results back to one site, for example, site A, corporate headquarters, or another corporate server. In example embodiments, the results may be reported to a server at a remote location (e.g., a hosted server in an application service provider (ASP)). In example embodiments, the Data Collection Server 100 may collect the results from the sensors 10, 20, 30.

The reported results may also be returned over a diverse medium (e.g., modem). Reports could be all BGP updates (e.g., the server may act just like a BGP server sending it updates to the server), only notifications about route changes for the remote office's or headquarters' addresses, or notifications about route changes that involve non-whitelisted providers. In example embodiments, various protocols could be used to report the results. In example embodiments, the results may be encrypted. For example, the results could be sent over a secure sockets layer (SSL) or using Transport Layer Security (TLS).

In example embodiments, one or more of the sensors 10, 20, 30 may also be capable of running a mechanism for tracing a route through the network, for example, traceroute, to the endpoints.

In example embodiments, a mechanism for tracing a route, for example, traceroute, may be used periodically to validate the BGP routes provided by the providers A, B, C. The mechanism for tracing a route can also run in response to a BGP route change (though the new BGP route may dictate the path, or at least the ASes used along the path). This may be useful in the event that a future attack modifies the routing without changing the BGP path. The traceroutes may run outside of the Data Connection 110 (for example, VPN) connecting site B (for example, the remote office) and site A (for example, headquarters). For example, the traceroutes could run between BGP servers or between access routers at site A and site B.

The dashed lines from the sensor 30 connected to Provider C show an illustrative example of the traceroute paths. In an example embodiment of the present invention, any element in the system of FIG. 4 may be capable of running traceroute. In the example embodiment shown in FIG. 4, the traceroute runs from the sensor(s) 10, 20, 30 toward one or more of the sites A, B.

In an example embodiment of the present invention, the detection, as described above, may compare the AS in the paths to and from the branch office and headquarters with, for example, whitelisted ASNs. Any non-whitelisted ASN may trigger an alarm. For unlisted ASNs, a human may intervene to assess the risk of the new provider.

Once a violation has been detected, example embodiments of the present invention may employ techniques to stop the traffic at each end. In example embodiments, the present invention may automatically disable the data connection 110 by closing it where the alarm is sent (presumably, headquarters). This may be sufficient to block the session in most cases. Because an attacker is suspected of manipulating the traffic, it is possible the attacker can drop the request to close the tunnel before it reaches the remote office. A second technique may be to close the data connection 110 at the remote end using an out-of-band approach, for example, making a telephone call to the branch office.

Example embodiments of the present invention may be effective to mitigate one or more attacks related to Internet routing. Table 2 lists objectives that may be the goal of an attack on Internet routing, for example, BGP routing.

TABLE 2

| Attack | |
|---|---|
| Objective | Description |
| Blackholing | An attacker affects routing so that packets cannot reach |
| | destination. |
| Redirection | An attacker causes AS to route traffic over non-optimal link |
| | (e.g., a low-bandwidth or expensive link) to cause (a) poor |
| | performance, (b) financial costs to the AS or revenue for |
| | another. |
| Subversion | A special case of redirection, this is where the attacker |
| | reroutes traffic to capture, eavesdrop, or modify it (e.g., |
| | launch further man-in-the-middle attack). |
| Instability | An attacker causes the routing protocol to become |
| | unstable (e.g., by causing excessive route flapping) to |
| | prevent neighboring ASes from routing through (or to) the |
| | victim). |

As set forth above, Table 1 lists specific attacks an attacker may use to attain one or more of these objectives.

Example embodiments of the present invention may be effective to mitigate subversion. The threats that best meet the objective of subversion are Path Padding, False Route, Address Ownership Violation, De-aggregation. Several other threats may reach the subversion objective by causing the routers to avoid an existing link (e.g., they cause an AS to reroute away from a primary link as a result of the attack).

In each case, an attacker may attempt to reroute traffic from, for example, a corporate headquarters in city A, connected to Reliable Provider 1, to the remote office in Town B, connected to Reliable Provider 3 such that the traffic goes through an adversary's network or an unreliable network, for example Unreliable Provider 1, where the adversary can capture the data packets.

FIG. 5 illustrates such as scenario in more detail. As shown in FIG. 5, the route from the headquarters should be [AS1 AS2 AS4 AS5], where a BGP route is denoted as a series of ASNs enclosed in square brackets. The route, read left to right, is the sequence of ASes used from source to destination. The attacker will attempt to get the traffic to use [AS1 AS2 AS3 AS6 AS5]. It is assumed that in the process of rerouting traffic to AS3 or AS6, the attacker does not create a condition that prevents the traffic from being routed to the remote office. For example, if necessary, once AS3 gets the traffic, AS3 can use static routing to deliver the packet to the original destination.

It is also noted that this example only shows the attack in one direction. Because Internet routing is asymmetric, the attacker generally would need to repeat the attack in the opposite direction to affect both paths.

The attacker may insert a false a path to cause an upstream AS to select a backup route to the destination prefix. The adversary may need to have access to a router along the path to inject the false advertisement. For example, the attacker may alter AS4's updates to use the path [AS4 AS4 AS4 AS5] instead of the usual [AS4 AS5].

The update may then propagate to AS2, which may select the shorter backup path [AS3 AS6 AS5]. AS2, in turn, withdraws the old path and advertises [AS2 AS3 AS6 AS5] to AS1.

An attacker may also insert a false route to force traffic through the target AS. For example, if AS3 advertises a direct route for AS5 to AS2, AS2 may choose the new path [AS3 AS6] over the equally distant old one [AS4 AS5]. If AS3 connected AS1, this attack might produce a strictly shorter path to the target guaranteeing that the attack would succeed.

A more direct attack may be to claim that the attacker's AS owns the target prefix. In such an example, AS3 may advertise that it owns 192.0.2.0/24. When AS3 receives the advertisement for the prefix, AS3 may select a shorter path to AS3. AS1, in turn, may select the path [AS2 AS3].

BGP routing is required to favor advertisements for prefixes with long masks over shorter masks (longer meaning the more bits set in the mask). For example, if an AS advertises two overlapping prefixes, 192.0.2.0/24 and 192.0.2.128/25, the route for the second prefix (with the 25 bit mask) is used to route addresses. To take advantage of this, an attacker may advertise routes from AS3 for the prefixes 192.0.2.0/25 and 192.0.2.128/25. The routes could include a path of any length (e.g., [AS3 AS6 AS5] or [AS3 AS5]). As these routes propagate, routers may select the new routes over the old one because of the prefix length. Thus, AS1 may use the path [AS2 AS3 AS6 AS5].

Each of the attacks affects Internet routing. Table 3 shows the original BGP path (as seen by corporate headquarters's provider) and the resulting path after the attack. As shown in Table 3, all the attacks may be readily detected by the provider.

TABLE 3
AS1's BGP Path after Attack

| Scenario | AS Path |
|---|---|
| Normal Routing | [AS2 AS4 AS5] |
| Path Padding | [AS2 AS3 AS6 AS5] |
| False Route | [AS3 AS5] |
| Address Ownership Violation | [AS2 AS3] |
| De-aggregation | [AS2 AS3 AS6 AS5] |

As described above, one or more of the sensors 10, 20, 30, the data collection server 100, the data connections 110, 120, the sites A, B and the providers A, B, C may be implemented by one or more processors, for example, routers, router cards, servers, server cards, PCs, PC cards, or other processing devices.

Although example embodiments described above are generally directed to methods, systems, and network entities applying techniques for layer 3, example embodiments of the present invention are equally applicable to layer 2. For example, for layer 2, a spanning tree algorithm may be used to detect changes, instead of the BGP techniques, disclosed above.

Although described primarily in terms of hardware above, the example methodology implemented by one or more components of the example methods, systems, and network entities described above may also be embodied in software as a computer program. For example, a program in accordance with the example embodiments of the present invention may be a computer program product causing a computer to execute a method of detecting data traffic re-routing, as described above.

The computer program product may include a computer-readable medium having computer program logic or code portions embodied thereon for enabling a processor to perform one or more functions in accordance with the example methodologies described above. The computer program logic may thus cause a processor to perform an example method, or one or more functions of the example methods described herein.

The computer-readable storage medium may be a built-in medium installed inside a computer main body or removable medium arranged so that it can be separated from the computer main body. Examples of the built-in medium include, but are not limited to, rewriteable non-volatile memories, such as RAM, ROM, flash memories and hard disks. Examples of a removable medium may include, but are not limited to, optical storage media such as CD-ROMs and DVDs; magneto-optical storage media such as MOs; magnetism storage media such as floppy disks, cassette tapes, and removable hard disks; media with a built-in rewriteable non-volatile memory such as memory cards; and media with a built-in ROM, such as ROM cassettes.

These programs may also be provided in the form of an externally supplied propagated signal and/or a computer data signal embodied in a carrier wave. The computer data signal embodying one or more instructions or functions of example methodologies may be carried on a carrier wave for transmission and/or reception by an entity that executes the instructions or functions of the example methodology. For example, the functions or instructions of the example method may be implemented by processing one or more code segments of the carrier wave in a computer controlling one or more of the components of the example systems of FIGS. 4-5, where instructions or functions may be executed for detecting data traffic re-routing, in accordance with the example methods outlined in FIGS. 4-5.

Further, such programs, when recorded on computer-readable storage media, may be readily stored and distributed. The storage medium, as it is read by a computer, may enable the processing of multimedia data signals prevention of copying these signals, allocation of multimedia data signals within an apparatus configured to process the signals, and/or the reduction of communication overhead in an apparatus configured to process multiple multimedia data signals, in accordance with the example method described herein.

It will be apparent to those skilled in the art that other changes and modifications may be made in the above-described example embodiments without departing from the scope of the invention herein, and it is intended that all matter contained in the above description shall be interpreted in an illustrative and not a limiting sense.

We claim:

1. A method of detecting data traffic re-routing between a first site and a second site, comprising:
receiving routing information for the data traffic between the first site and the second site;
detecting a change in the routing information; and
determining if all intermediate network elements in the changed routing information are acceptable.

2. The method of claim 1, wherein the routing information includes border gateway protocol (BGP) updates.

3. The method of claim 1, wherein the routing information includes information from a spanning tree algorithm.

4. The method of claim 1, wherein the routing information for the data traffic between the first site and the second site is received from at least one sensor.

5. The method of claim 1, wherein the changed route information is detected by a traceroute.

6. The method of claim 1, wherein all intermediate network elements in the changed routing information are determined by comparing all the intermediate network elements in the changed routing information with a list of network elements acceptable for use between the first site and the second site.

7. The method of claim 6, further comprising:
validating the data traffic between the first site and the second site via the changed route if the changed route information is acceptable.

8. The method of claim 6, further comprising:
terminating the data traffic between the first site and the second site via the changed route if the changed route information is not acceptable.

9. A system for detecting data traffic re-routing between a first site and a second site, comprising:
at least one sensor receiving routing information and changes in routing information for the data traffic between the first site and the second site; and
at least one data collection device for collecting the routing information and changes in routing information from the at least one sensor and for determining all intermediate network elements in the changed routing information are acceptable.

10. The system of claim 9, wherein the routing information includes border gateway protocol (BGP) updates.

11. The system of claim 9, wherein the routing information includes information from a spanning tree algorithm.

12. The system of claim 9, wherein the changed route information is detected by a traceroute.

13. The system of claim 9, wherein the at least one data collection device determines all intermediate network elements in the changed routing information are acceptable by comparing all the intermediate network elements in the changed routing information with a list of network elements acceptable for use between the first site and the second site.

14. The system of claim 13, wherein at least one of the first site and the second site validates the data traffic between the first site and the second site via the changed route if the changed route information is acceptable.

15. The system of claim 13, wherein at least one of the first site and the second site terminates the data traffic between the first site and the second site via the changed route if the changed route information is not acceptable.

16. The system of claim 9, wherein the data traffic between the first site and the second site is routed through at least one provider and at least one sensor is provided for each of the at least one providers.

17. A network entity for detecting data traffic re-routing between a first site and a second site, comprising:
at least one data collection device for collecting routing information and changes in routing information from at least one sensor and for determining all intermediate network elements in the changed routing information are acceptable.

18. The network entity of claim 17, wherein the routing information includes border gateway protocol (BGP) updates.

19. The network entity of claim 17, wherein the routing information includes information from a spanning tree algorithm.

20. The network entity of claim 17, wherein the changed route information is detected by a traceroute.

21. The network entity of claim 17, wherein the at least one data collection device determines all intermediate network elements in the changed routing information are acceptable by comparing all the intermediate network elements in the changed routing information with a list of network elements acceptable for use between the first site and the second site.

22. The network entity of claim 21, wherein at least one of the first site and the second site validates the data traffic between the first site and the second site via the changed route if the changed route information is acceptable.

23. The network entity of claim 21, wherein at least one of the first site and the second site terminates the data traffic between the first site and the second site via the changed route if the changed route information is not acceptable.

24. The system of claim 17, wherein the data traffic between the first site and the second site is routed through at least one provider and at least one sensor is provided for each of the at least one providers.

25. The network entity of claim 17, wherein the at least one data collection device reports unacceptable changed routing information to at least one of the first site and the second site.

26. The network entity of claim 17, wherein another network entity, at one of the first site and the second site, terminates the data traffic between the first site and the second site via the changed route if the changed route information is not acceptable.
